(19) United States
(12) Patent Application Publication
(10) Pub. No.: US 2001/0020752 A1
(43) Pub. Date: Sep. 13, 2001

(54) Dielectric material composition

(76) Inventors: Joris Schryvers, Antwerpen (BE); Petrus Van Roy, Diest (BE); August Timmerman, Westerlo (BE)

Correspondence Address: SUGHRUE, MION, ZINN, MACPEAK & SEAS, PLLC, 2100 Pennsylvania Avenue, N. W., Washington, DC, 20037-3213, US

(21) Appl. No.: 09/782,041

(22) Filed: Feb. 14, 2001

(30) Foreign Application Priority Data
Feb. 14, 2000 (EP) 00870020.5

(51) Int. Cl. B29D 11/00; H01Q 19/06

(52) U.S. Cl. 264/1.1; 264/1.24; 264/1.7; 343/753; 343/754; 425/808

(57) ABSTRACT

The present invention relates to a method for producing a shell for a Luneberg lens in which an amount of a dielectric material composition containing particles of an expandable plastic material coated with an amount of a titanium-oxygen compound, is introduced into a mould and heated to an appropriate temperature for moulding. As a plastic material use is made of an expandable plastic material which is non-expanded or partly pre-expanded. The moulding temperature is selected such that expansion of the particles takes place. As an expandable plastic material preferably use is made of polystyrene. The dielectric moulding composition preferably comprises 5-65 wt. % of the titanium-oxygen compound with respect to the total weight of the composition.

### BACKGROUND OF THE INVENTION

The present invention relates to a dielectric material composition as described in the preamble of the first claim.

Dielectric materials find numerous applications, e.g. in printed circuit boards, in lens antennas and passive reflectors as is disclosed in Electronic Design, Apr. 13, 1960 by E. F. Buckley “Stepped-index Luneberg lenses: antennas and reflective devices.” By placing a small and broad beamed feed antenna with its effective phase centre at the focal radius of the lens, an efficient lens antenna results because all energy radiated into the forward hemisphere is theoretically collimated. By covering a portion of the surface of the lens with a metallic reflector, the combination of the reflector and the lens serves as a passive reflector of microwave energy throughout a solid angle equal to that subtended by the reflector.

Luneberg lenses are mostly spherical symmetric lenses that are built up of a plurality of individual lens shells that fit into each other to form a sphere of pre-determined dimensions. The geometry of the lens is namely dictated by the frequency of the radiation involved. The focusing properties of such a lens are defined by the relationship dielectric constant—radius of the spherical shells. Ideally, the relationship between the relative dielectric constant k and the dimensioless radius r=R/R° where R is the mean radius of an individual shell and R° is the outer radius of the lens, of the individual shells is given by:

$$k = 2 - {r}^{2} \qquad \text{formula I}$$

in the range 0≦r≦1. In general, it is required that the variation of the relative dielectric constant is between 1 at the surface of the spherical lens and 2 at the centre.

To achieve a smooth variation of the dielectric constant from the centre towards the lens surface, lenses have been made in which a series of circular shells of different radii are fit into one another to approximate a sphere. To reduce the dielectric constant k to the correct value at each point in the sphere, holes are drilled in each shell. Such shells however are neither homogeneous nor isotropic. In another solution the lens is made of foamed plastic materials the density of which is varied to reduce the dielectric constant k to the correct value at each point in the sphere. In that way a stepwise approximation to formula I defining the relation between k and r, can be achieved. An optimal approximation to the theoretical smooth curve of k can be achieved if the number of shells is as large as possible. Economy of fabrication however dictates to keep the number of shells required as low as possible.

To allow k to be further varied, use has been made of dielectric material compositions in which a high-k material, such as titanium dioxide is dispersed as a powder in a low-k material, usually a powder of a plastic material. After dispersion of the titaniumdioxide in the plastic material the composition is subjected to a foaming step, so as to achieve the desired density. However, these compositions have not been widely employed in Luneberg lenses.

One of the reasons is that because of the relatively large difference between the density of the plastic material and the titanium dioxide, the distribution of the titaniumdioxide in the plastic material is insufficiently homogeneous. As a consequence thereof a shell made of such a material will show a non-uniform dielectric constant.

From U.S. Pat. No. 4,288,337 a dielectric composition is known wherein expanded polystyrene particles are coated with a metal film. Mixing such coated particles with untreated expanded polystyrene may lead to the desired dielectric constant. Such a process however involves an additional process step as both coated and uncoated particles need to be mixed. In order to achieve a homogeneous mixing, it is adviseable that the coated and uncoated plastic material particles have approximately the same density. Furthermore, since metal-metal contacts have to be avoided as they give rise to undesired dielectric losses, the amount of metal coated particles that can be incorporated in the mixture, is limited. As a consequence, the range of dielectric constants that can be achieved with such a mixture is limited. Finally, it is adviseable to add a binder material to optimise the adhesion between the metal coated and the non coated particles. This again involves an additional process step.

The problem of providing a lense with a dielectric constant which is uniform throughout each shell is solved by GB-A-1.085.257. This is achieved according to GB-A-1.085.257 in that foam beads that have been expanded to a predetermined extent by heating before forming into a shell, are intimately mixed with powdered titanium oxide and a suitable binder. The titanium oxide coated beads are introduced into a mould. The mould is heated to accelerate the evaporation of the liquid in the binder, thereby care being taken that the temperature is not raised to such a level that the beads are further expanded. Subsequent, concentric shells are joined to each other by a binder material. As the beads are not allowed to expand when moulding, voids will remain between the beads, which adversely affects the homogeneity of the shell.

U.S. Pat. No. 2,943,358 solves the problem of providing a Luneberg lense in which a stable expanded dielectric plastic substance of relatively low dielectric constant is used a the matrix for the production of the shells. Pre-expanded polystyrene beads with a predetermined bulk density, are screened to select those beads the diameter of which ranges within pre-set limits. The beads of the plastic material are coated with titanium dioxide to obtain beads with a predetermined dielectric constant and stored according to bulk density until fabrication into shells with the appropriate dielectric constant for a Luneberg lens. When moulding a shell, an amount of beads appropriate for the formation of a shell with a predetermined diameter is sprayed with just enough of a binder emulsion to dampen their surfaces, and poured into a hemispherical mold element in a layer with a predetermined thickness. An air flow is blown over the beads to dry the emulsion.

However, as the beads are not allowed to expand when moulding, voids will remain between the beads, which adversely affects the homogeneity of the shell. There is thus a need to a process with which the homogeneity of the shells may be improved.

It is the aim of the present invention to provide a method for the production of shells for Luneberg lenses with an improved homogeneity.

### SUMMARY OF THE INVENTION

This is achieved with the present invention with the features of the characterising part of the first claim.

To keep the density and thus the weight of the shell as low as possible, and to minimise the presence of voids between individual particles in the finished shell, the composition preferably contains an expandable plastic material which is non-expanded or partly expanded before moulding. When moulding the particles the temperature of the mould is increased to such a level as to cause further expansion of the particles. With this further expansion of the plastic material, voids remaining between the initial particles may be occupied by the expanded particle material. The inventor has now found that due to the absence of voids the over-all homogeneity of the dielectric constant of the shell may be improved, irrespective of the presence of a coating on the external surface of the plastic material particles. There is no teaching in the prior art publications that coated particles can be further expanded when moulding into a part, without this adversely affecting the characteristics of the part.

Depending on the nature of the plastic material, it may have a relatively low k value, whereas the k of titanium-oxygen compounds is significantly higher. As a consequence, a relatively small amount of the titanium-oxygen compound suffices to increase the k value of the composition, so that the density of the composition and consequently the density and weight of a lens made of such composition can be kept low. This is important in modern applications of the composition, for example in antennas where severe restrictions with respect to the weight of the antenna are imposed by law, while simultaneously the material the antenna is made of should have at least a pre-determined k so as to allow the antenna to be used for its application.

Also, by varying the expansion degree of the plastic material, additional variations may be introduced to the density and thus the dielectric constant of the coated particles.

With the method of this invention dielectric compositions can be provided which have a bulk density that may vary from approximately 150 to approximately 700 g/l, a dielectric constant of between approximately 1.2-10, preferably 1.2-5 and dielectric losses of below approximately 0.005. The latter is important as it adversely affects the functioning of the lens. Up to now materials that simultaneously show a low density, high k and low dielectric losses within the above disclosed ranges had not been available.

### DETAILED DESCRIPTION OF THE INVENTION

The plastic material used in the method of the present invention may be any suitable expandable plastic material known to the man skilled in the art. Suitable plastic materials include expandable homopolymers or copolymers of polypropylene, polyethylene, ABS, polyvinylchloride, polystyrene etc.

Polystyrene is preferred over the other expandable materials because of its excellent dimensional stability in the sense that the shrink after expansion is limited. This is important as Luneberg lenses are mostly built up of a plurality of interconnected concentric shells and as the plastic material is allowed to expand while moulding it into a part, for example a lens part of a pre-determined shape and pre-determined dimensions. In Luneberg lenses namely, parts of increasing dimensions have to fit closely to each other to allow a spherical lens with a homogenous lens behaviour to be obtained. Polystyrene further has a relatively low density combined with low dissipation losses.

The polystyrene particles used in the method of this invention may be non expanded or partly pre-expanded before being moulded into a part. The use of partly pre-expanded particles is preferred because of their larger volume due to which the titanium-oxygen coating can be applied in an optimum manner. Whereas a non-expanded polystyrene for example may have a material density of approximately 1050 g/l and a bulk density of 600-700 g/l, the bulk density of expanded polystyrene may be decreased to 10-300 g/l, preferably 60-300 g/l depending on the degree of expansion, but is preferably at least 60 g/l. However, polystyrene particles with lower or higher densities may be used, the maximum possible density corresponding to the density of non-expanded polystyrene, the density preferably being at least 60 g/l. By varying the degree of expansion of the plastic material, the density of the coated particles may be varied to a larger extent.

In the method of this invention use may be made of the titanium oxide compounds generally known to the man skilled in the art. Examples of suitable titanium-oxygen compounds include titaniumdioxide, bariumtitanate BaTiO₃, strontiumtitanate SrTiO₃, but other titanium-oxide compounds may be used. Preferably use is made of titaniumdioxide because of its high k value which may vary from approximately 80 to approximately 100, combined with a low dissipation factor (low dielectric losses), a relatively low density of approximately 3.8-4.3, good stability as a function of temperature of the dielectric behaviour and because it is easily commercially available. The use of titaniumdioxide allows a lens to be obtained with a relatively low weight at high k-value and low dissipation losses.

Besides titanium-oxygen compounds, also other compounds with a suitable dielectric constant may be used contained in the coating. Possible examples include ceramic powders, for example silicondioxide, siliconcarbide, siliconnitride, magnesiumoxide etc.

Titaniumdioxide is preferably added in an amount of 5-65% by weight with respect to the total weight of the composition. Below this range the volume of the titaniumoxide used gets small, which on the one hand may result in a coating with an insufficient homogeneity and on the other hand affect the k-value to only a small or negligible extent. Above this range there is a risk to a decreasing adhesion of titanium oxide to the plastic material. As the presence of the coating hampers expansion of the non or partly expanded plastic material, care should be taken to find the optimum compromise between allowing a sufficient expansion to take place and obtaining a composition with the desired k value.

The mean particle size of the non expanded or partly expanded particles of the plastic material to be coated with the titanium-oxygen compound is preferably maintained within well defined ranges so as to allow an optimum and uniform coating to be obtained. Non-expanded particles for example have an average diameter of between 0.7-1.0 mm, partly expanded particles may for example have an average diameter of between 1.0-2.0 mm. However, the average diameter of the particles may be altered if necessary.

The thickness of the titanium-oxygen coating is preferably below 50 μm, more preferably below 10 μm.

To improve the binding of the titanium-oxygen compound coating on the particulate plastic material, the composition preferably contains an apolar adhesive or binder, for example a wax, a polyurethane resin or an epoxy resin. The use of an apolar binder allows to minimise the dissipation factor. The binder is preferably used in an amount of 1-25 percent by weight of solid binder with respect to the total weight of the composition. The volume ratio of the binder with respect to the titanium-oxygen compound is preferably at least 1/4 in order to allow the titanium-oxygen compound to be sufficiently captured in the binder material.

The present invention also relates to a dielectric material composition for use with the above described method.

The present invention also relates to parts, in particular a lens or an antenna made of a material comprising the dielectric composition of this invention.

In a possible embodiment of the method of this invention for producing a shell or shell part for a Luneberg lens, the plastic material particles may be dried to remove excess water before coating them. This is however not necessary as they will be contacted with water again when applying the titanium-oxygen coating.

The non-expanded or partly pre-expanded particles are contacted with a, aqueous dispersion or solution of the titanium-oxygen compound. The binder is preferably applied as a binder emulsion so as to allow a uniform application and a uniform adherence of the titanium-oxygen compound to be achieved. It is however also possible to contact the plastic material particles with an emulsion of the titanium-oxygen compound and the binder material. The mixture is thoroughly mixed to obtain a homogeneously coated material. The thus coated particles may be dried to remove excess water. This allows minimising the occurrence of dielectric losses and improving the free flowing behaviour of the particles, thus facilitating and improving the homogeneity of the filling of the mould. Drying of the coated particles is preferably performed in the course of the mixing process in the preparation of the dielectric composition. The composition is moulded in a mould at a predetermined temperature and pressure. It is however also possible to first mix the plastic material particles with an emulsion of a binder material and the titanium-oxygen compound.

As a plastic material, either a non expanded or a partly expanded material is used, depending on the density of the final product aimed at. The use of non expanded or partly expanded material allows to avoid the formation of gas inclusions in the moulded part. The density of the final product can be further controlled by controlling the moulding temperature, as this determines the expansion of the plastic material in the course of the moulding process. Often, steam is blown into the mould to cause expansion of the plastic material. After the plastic material has expanded to the desired extent, vacuum is applied so as to remove the excess of foaming agent and water from the mould as the former may affect the dimensional stability of the moulded part, whereas the latter may adversely affect the dielectric properties of the material. Finally, the moulded part is subjected to a drying step to remove any remaining water.

The invention is further illustrated in the following examples.

### EXAMPLE 1

35 parts by weight of partly pre-expanded polystyrene homopolymer with a density of 150 g/l were mixed with 20 parts by weight of a water diluted wax solution which contained 15 parts of solid wax. Then, 45 parts by weight of TiO₂ were added so as to obtain an optimal wetting of the TiO₂. The mixture was moved during a sufficiently long period to ensure that all particles are well wetted and that the excess of water present in the wax emulsion is evaporated.

After the particles had been coated with TiO₂, an amount of the coated particles was introduced into a mould and moulded into a part. The mould was closed and heated to 100° C. by immersion in boiling water. After approximately 15 minutes, the moulded part was removed from the mould and allowed to dry at 70° C. for 10 hours.

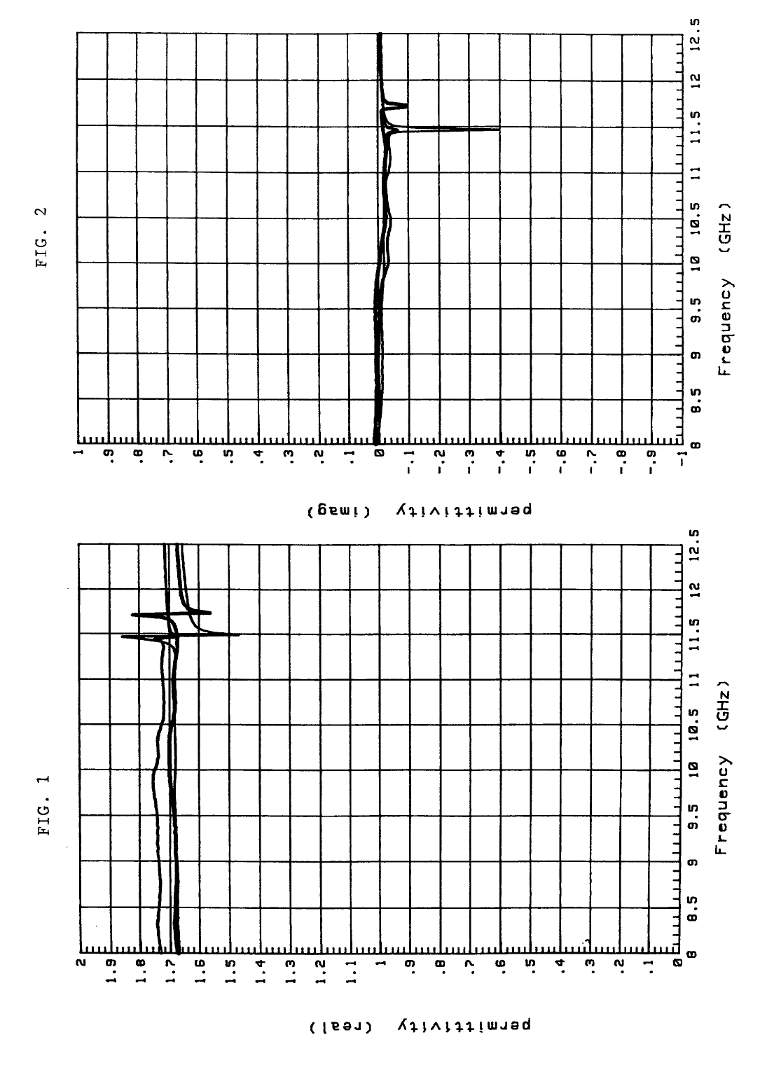

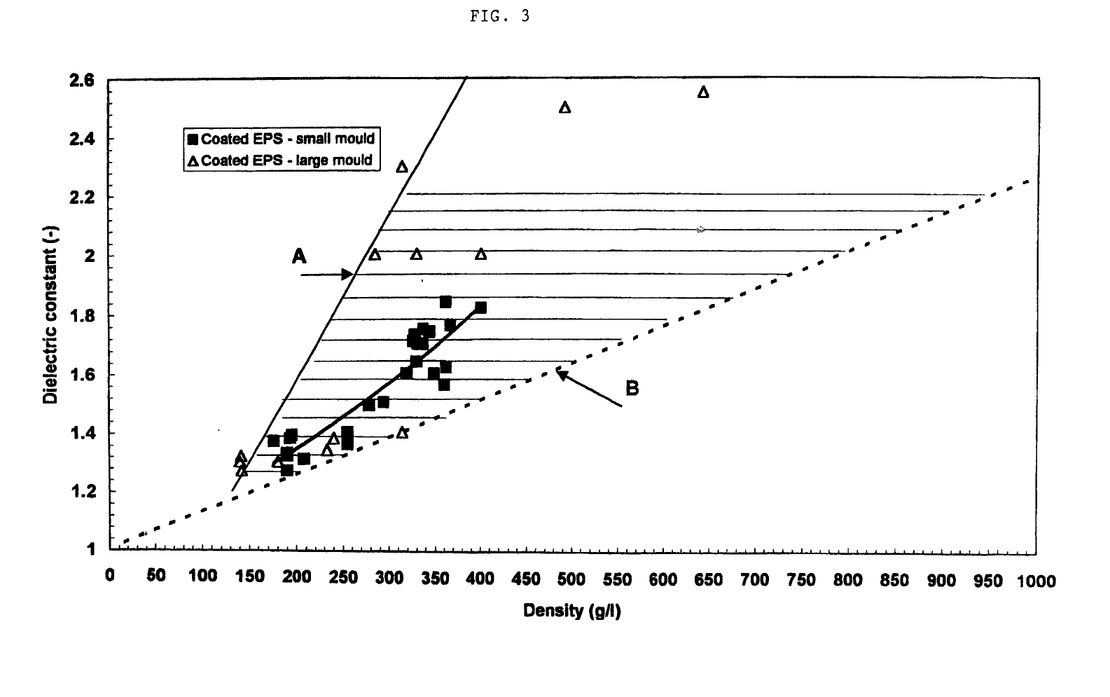

The part was characterised by determining the dielectric properties or permittivity of the material. The real part of the permittivity between 8 and 12.5 Ghz (X-band) is shown in FIG. 1, the imaginary part is shown in FIG. 2.

### EXAMPLE 2

Additional compositions were prepared as described in Example 1, except that the amount of filler and/or binder was varied as given in table 1, and that use was made of partly pre-expande polystyrene particles with varying degree of expansion (ref. 4 and 5 in table 1). Table 1 also gives the variation of k as a function of the density of the composition. As can be seen from FIG. 3, compositions with a density of up to 400 g/l can be obtained at dielectric constants as high as 1.8. By further varying the density of the polystyrene particles and the amount of wax and/or titaniumdioxide, compositions can be made with even a higher dielectric constant for example up to 2.2 and a density of about 600 g/l. Dielectric losses of the various materials were below 0.005.

The range of density/dielectric constant combinations that can be achieved with a polystyrene, TiO₂ composition is shown by the solid lines A, B in FIG. 3. This range is mainly determined by the degree of pre-expansion of the polystyrene particles.

TABLE 1
Compositions as mixed.

| Sample n° | 1 | 2 | 3 | 4 | 5 |
|---|---|---|---|---|---|
| EPS (parts by weight) | 50 | 35.0 | 25 | 65 | 67.1 |
| Wax emulsion, 15 parts by | 14.2 | 20.0 | — | 17.5 | — |
| weight of solid wax | | | | | |
| Wax emulsion, 60 parts by | — | — | 25.0 | — | 11 |
| weight of solid wax | | | | | |
| TiO₂ | 35.7 | 45.0 | 50.0 | 17.5 | 21.9 |
| Density | 294 | 330 | 492 | 642 | 550 |
| Permittivity | 1.5 | 1.7 | 2.5 | 2.6 | 2.75 |

TABLE 2
Compositions as dried.

| Sample n° | 1 | 2 | 3 | 4 | 5 |
|---|---|---|---|---|---|
| EPS (parts by weight) | 56.9 | 42.2 | 27.8 | 79.3 | 70.2 |
| Solid wax | 2.4 | 3.6 | 16.7 | 3.15 | 6.9 |
| TiO₂ | 40.7 | 54.2 | 55.5 | 20.6 | 22.9 |
| Density | 294 | 330 | 492 | 642 | 550 |
| Permittivity | 1.5 | 1.7 | 2.5 | 2.6 | 2.75 |

What is claimed is:

1. A method for producing a shell for a Luneberg lens in which an amount of a dielectric material composition, containing particles of an expandable plastic material coated with an amount of a titanium-oxygen compound, is introduced into a mould and heated to an appropriate temperature for moulding it into he shape of a shell, characterised in that as a plastic material use is made of an expandable plastic material which is in a non-expanded or partly pre-expanded state and in that the moulding temperature is selected such that expansion of the particles takes place when moulding the shell.

2. A method as claimed in claim 1, characterised in that the titanium-oxygen compound is titanium dioxide.

3. A method as claimed in any one of claims 1 or 2, characterised in that the composition comprises 5-65 wt. % of the titanium-oxygen compound with respect to the total weight of the composition.

4. A method as claimed in any one of claims 1-3, characterised in that the composition comprises 1-25% by weight of a solid binder with respect to the total weight of the composition.

5. A method as claimed in any one of claims 1-4, characterised in that the expandable plastic material is polystyrene.

6. A method as claimed in claim 5, characterised in that the expanded polystyrene has a density of between 60 g/l - 300 g/l.

7. A dielectric composition for use in the method of any one of claims 1-6, characterised in that the composition contains particles of an expandable plastic material, the particles being non or partly pre-expanded, and coated with a coating of a titanium-oxygen compound.

8. A dielectric composition as claimed in claim 7, characterised in that the composition has a density of between 150 g/l-700 g/l.

9. A dielectric composition as claimed in claim 7 or 8, characterised in that the titanium-oxygen coating has a thickness ≦50 μm

10. A sphere or hemispherical shell for a Luneberg lens comprising a composition as claimed in any one of claims 7-9.
